(19) United States
(12) Patent Application Publication
(10) Pub. No.: US 2005/0119767 A1
(43) Pub. Date: Jun. 2, 2005

(54) Configuration application for building automation

(76) Inventors: Gary Kiwimagi, Greeley, CO (US); Charles McJilton, Longmont, CO (US); Mark Gookin, Loveland, CO (US)

Correspondence Address: TRENNER LAW FIRM, LLC, 12081 WEST ALAMEDA PARKWAY #163, LAKEWOOD, CO, 80228, US

(21) Appl. No.: 10/999,253

(22) Filed: Nov. 30, 2004

Related U.S. Application Data
(60) Provisional application No. 60/526,211, filed on Dec. 1, 2003.
(60) Provisional application No. 60/607,810, filed on Sep. 8, 2004.

(51) Int. Cl. G05B 11/01

(52) U.S. Cl. 700/19; 700/83; 715/734

(57) ABSTRACT

Implementations described and claimed herein provide systems (e.g., a computer program product) and methods of configuring automation devices in a building automation system. An exemplary method includes acquiring an electronic layout for the building automation system. The electronic layout may be populated with a plurality of automation devices. Relationships may be established among the automation devices in the electronic layout. In other exemplary implementations, operation of the automation devices may be simulated in software, and documentation may be generated for the building automation system.

### PRIORITY CLAIM

This application claims priority to co-owned U.S. Provisional Patent Application Ser. No. 60/526,211 for “Building Automation Integration and Control” of Kiwimagi, et al., Attorney Docket No. CVN.014.PRV (formerly CN1-014USP1), Filed Dec. 1, 2003, and co-owned U.S. Provisional Patent Application Ser. No. 60/607,810 for “Simulation Software for Building Automation Configuration” of Kiwimagi, et al., Attorney Docket No. CVN.026.PRV, filed Sep. 8, 2004, each hereby incorporated herein for all that these applications disclose.

### TECHNICAL FIELD

The described subject matter relates to building automation, and more particularly to configuration applications for building automation.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

Building automation systems may include controls which are typically hard-wired for specific automation devices and pre-programmed to control the devices in a prescribed manner. Such systems cannot be readily customized or changed for individual users or changes to the building automation system (e.g., adding or removing automation devices). More sophisticated building automation systems may be provided with computer controls. However, configuring and reconfiguring such computer controls requires advanced programming skills increasing the cost of installation and maintenance. Operating a building automation system with advanced computer controls can also be intimidating to use and often the full potential of such systems is not realized.

### SUMMARY

Implementations described and claimed herein include systems and methods of configuring a building automation system. In some implementations, articles of manufacture are provided as computer program products. One implementation of a computer program product includes acquiring an electronic layout for the building automation system, populating the electronic layout with a plurality of automation devices, and establishing relationships among the automation devices in the electronic layout. A method of configuring automation devices in a building automation system is also disclosed.

In another exemplary implementation, a method of reporting errors for automation devices in a building automation system comprising: identifying a device error in the building automation system, connecting to the building automation system, and reporting the device error for real-time analysis.

In another exemplary implementation, a method of configuring automation devices for a building automation system in real-time comprising: identifying an automation device in an electronic layout of the building automation system, adjusting a program for the automation device, controlling the automation device, programming the automation device with the adjusted program.

### BRIEF DESCRIPTION OF THE DRAWINGS

FIG. 1 is a schematic illustration of an exemplary building automation system.

FIG. 2 is a functional diagram illustrating an exemplary implementation of a configuration application for configuring a building automation system.

FIGS. 3-8 are exemplary graphical user interfaces (GUIs) that may be implemented by a configuration application for a building automation system.

FIG. 9 is a flow diagram illustrating exemplary operations for configuring a building automation system.

FIG. 10 is a flow diagram illustrating exemplary operations for commissioning a building automation system.

FIG. 11 is a flow diagram illustrating exemplary operations for automatic error reporting for a building automation system.

FIG. 12 is a flow diagram illustrating exemplary operations for programming automation devices for a building automation system in real-time.

### DETAILED DESCRIPTION

In exemplary implementations shown and described herein a configuration application (e.g., software) may be provided for configuring a building automation system. The configuration application allows an integrator (or other user) to acquire an electronic layout of the building, e.g., by importing an electronic image file of the building floor plan. The integrator may “drag and drop” graphical cons representing various automation devices onto the electronic layout, connect the devices, and customize operation operation of the devices. The configuration application also generates program code (e.g., scripts) for controlling the automation devices. Operations may be simulated in software before installation and commissioning the building automation system (e.g., by delivering the scripts to the installed automation devices). The installed automation devices may be tested before commissioning the building automation system.

In exemplary implementations, the configuration application allows the integrator to design the building automation system using a scale layout of the building. The configuration application also shows connections between layouts. For example, the integrator may “click” on a keypad icon shown in the second floor layout to see automation devices the keypad controls on the first floor.

Also in exemplary implementations, the configuration application may automatically generate documentation for the building automation system. For example, the configuration application automatically generates a bill of materials (BOM) for the installer including a detailed equipment list and pricing. Documentation may also include device labels (e.g., identifying functions for a keypad device), wiring diagrams and labels, installation instructions, etc., to improve installation and operation of the building automation system.

The configuration application also provides error reporting and allows changes to be made in real-time. For example, the building owner may stand in the media room and ask the integrator to increase the lighting levels. The integrator can make the requested changes to the device program and runs the program for the building owner.

Although exemplary implementations are described herein with reference to building automation systems, it should be understood that the scope is not limited to use with building automation systems and the invention may also find application in a number of different types of automation systems now known or later developed.

### Exemplary Systems

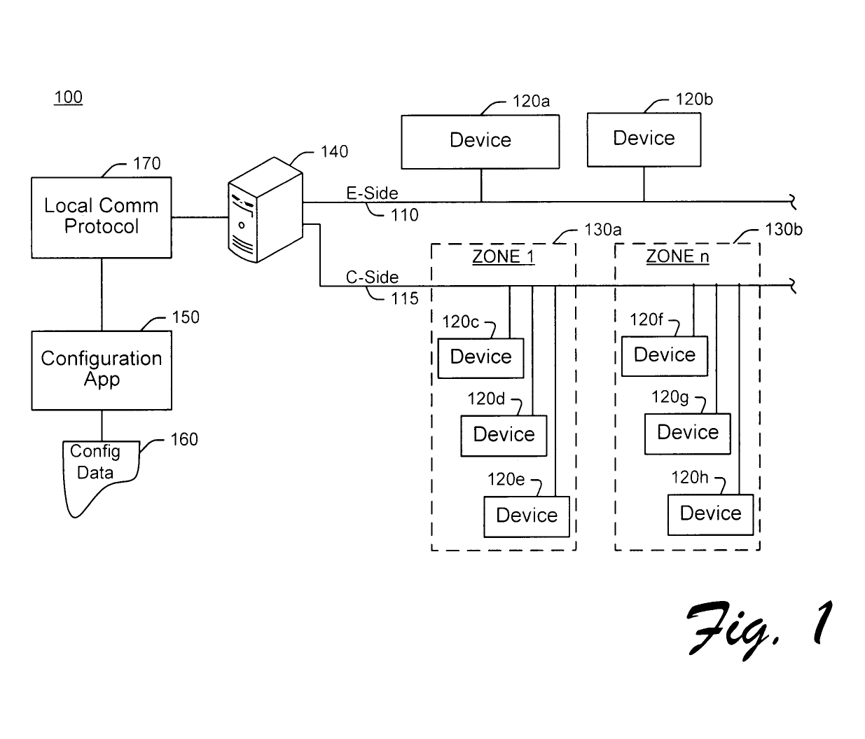

FIG. 1 shows an exemplary building automation system 100 as it may be used to automate various functions in a home or other building (e.g., apartment complex, hotel, office building). By way of example, the building automation system 100 may be used to control lighting, heating, air conditioning, audio/visual distribution, operating window coverings to open/close, and security, to name only a few examples.

Building automation system 100 may include one or more communication networks, such as Ethernet network 110 (referred to herein as the “E-Side”) and a controller area network or CAN bus 115 (referred to herein as the “C-Side”). Ethernet networks are well understood. Implementations of a building automation system including a CAN bus are described in more detail in co-owned U.S. patent application Ser. No. 10/382,979, entitled “Building Automation System and Method” of Hesse, et al. filed on Mar. 5, 2003.

Briefly, the CAN bus may be implemented using a two-wire differential serial data bus. The CAN bus is capable of high-speed data transmission (about 1 Megabits per second (Mbits/s)) over a distance of about 40 meters (m), and can be extended to about 10,000 meters at transmission speeds of about 5 kilobits per second (kbits/s). It is also a robust bus and can be operated in noisy electrical environments while maintaining the integrity of the data.

It is noted that building automation system 100 is not limited to use with any particular type of communications network. Other networks may include, e.g., RS-232 networks, and wireless networks to name only a few examples.

Building automation system 100 may include one or more automation devices, such as E-side devices 120a-b and C-side devices 120c-h (hereinafter generally referred to as automation devices 120). The automation devices 120 may include any of a wide range of types and configurations of devices. Examples include, e.g., security sensors, temperature sensors, light sensors, timers, touch pads, and voice recognition devices, to name only a few.

Automation devices 120 may be provided in building automation zones 120a-b. Building automation zones 130a-b may be defined geographically, such as by room (e.g., the living room) or group of rooms (e.g., the first floor of a house). Alternatively, zones may be defined by functionality, such as security devices or lighting devices. In any event, any number of zones 130a-b may be defined for the building automation system 100.

Automation devices 120 may be communicatively coupled to one another in the building automation system 100 via a bridge 140 to facilitate communications between the different types of networks. The term “bridge” as used herein refers to both the hardware and software (the entire computer system) and may be implemented as one or more computing systems, such as a server computer.

It is noted therefore that the bridge 140 may also perform various other services for the building automation system 100. For example, bridge 140 may be implemented as a server computer to process commands for automation devices, provide Internet and email services, broker security, and optionally provide remote access to the building automation system 100.

A configuration application 150 may be provided for configuring the automation devices in the building automation system 100. Configuration application 150 is described in more detail below. Briefly, however, the configuration application 150 integrates device configuration data 160 (e.g., from an integrator or other user) and configures automation devices 120 for operation in the building automation system 100. In an exemplary implementation, configuration application 150 generates program code (e.g., scripts) for controlling the automation devices 120. The program code may be stored at the automation devices 120 and/or at the bridge 140 so that the configuration application 150 may be removed from the system for operation.

Configuration application 150 may communicate with the bridge 140 during integration, e.g., to test the automation devices and/or upload program code for controlling the automation devices during operation. Configuration application 150 may communicate with the bridge 140 via a communications protocol 170.

In an exemplary implementation, the communication protocol 170 may be implemented as a local communications protocol on the e-side intranet so that the configuration application 150 is able to configure the building automation system 100 from inside a local firewall. Data may be transferred via HTTP. HTTP reduces the amount of required redundancy when the remote communication protocol is enabled.

Communication messages may be defined for the communication protocol 170. In an exemplary implementation, the following messages are defined: connect; data upload; process data upload; and data download. The messages enable the configuration application 150 to control the bridge 140.

For purposes of illustrating operation, the configuration application 150 may request the device IDs of automation devices 120. The configuration application 150 maps the device IDs and ESN to logical icons on the home map. The configuration application 150 requests the device ID and ESN for the next item that reports activation (e.g., when a button on the automation device is depressed). The configuration application 150 issues a “Connect” command to the bridge 140 and then issues a “Data Download” command for the device ID and electronic serial number (ESN). The bridge 140 returns the requested data.

As a further illustration of operation, the configuration application 150 may upload scripts to the bridge 140 and/or automation devices 120 by issuing a “Connect” command to the bridge. A series of “Data Upload” command are issued to send the scripts to the bridge 140. A “Process Data Upload” command is then issued to the bridge 140 for processing the scripts.

It is noted that the building automation system 100 is not limited to any particular type or configuration. The foregoing example is provided in order to better understand one type of building automation system 100 in which the configuration application 150 described herein may be implemented. However, the system and methods may also be implemented in other types of automation systems. The particular configuration may depend in part on design considerations, which can be readily defined and implemented by one having ordinary skill in the art after having become familiar with the teachings of the invention.

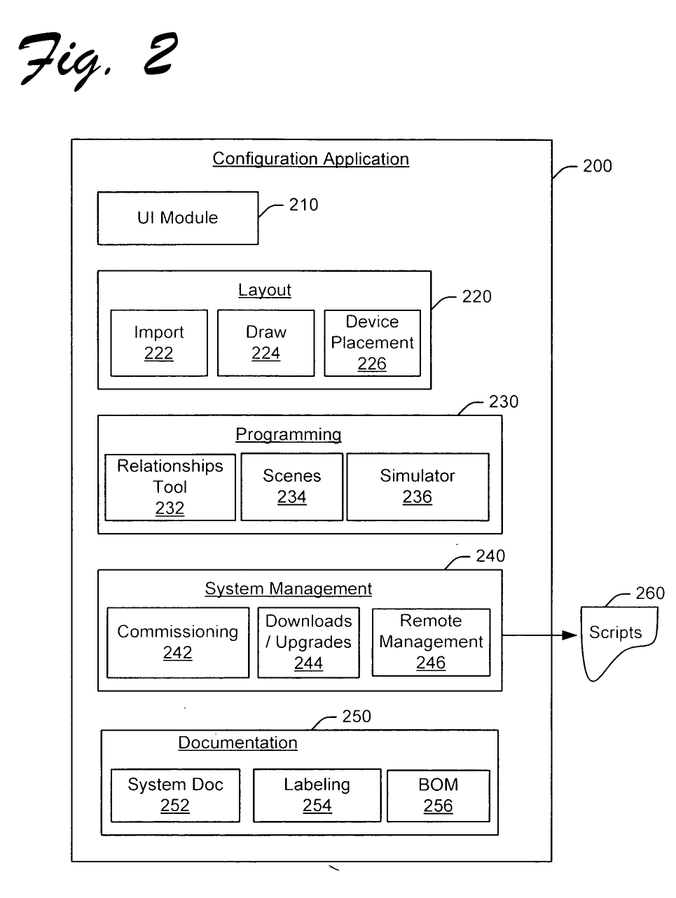

FIG. 2 is a functional diagram illustrating an exemplary implementation of a configuration application 200 for configuring a building automation system (such as the building automation system 100 in FIG. 1). Exemplary configuration application 200 may be implemented as computer-readable program code product (e.g., software). Configuration application 200 may include functional modules, such as, e.g., a user interface (UI) module 210, a layout module 220, a programming module 230, a system management module 240, and a documentation module 250.

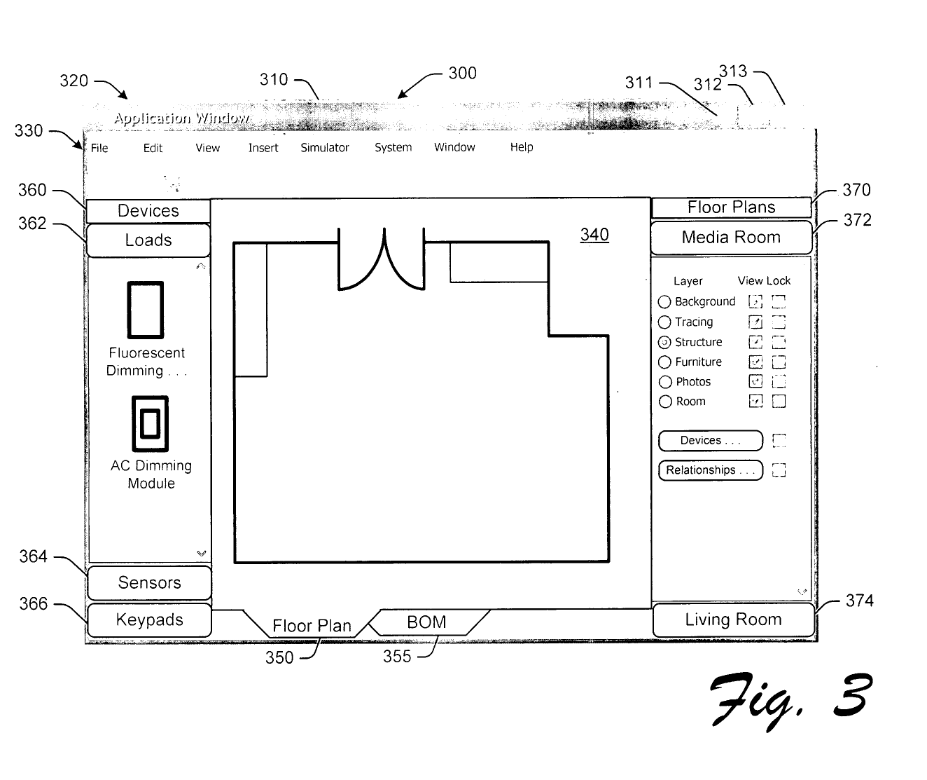

User interface (UI) module 210 may be implemented to output and input data to a user in a Microsoft WINDOWS® or other graphical user interface operating environment. UI module 210 may interact with other functional modules, with external applications (e.g., imaging software, computer-aided design software), and/or with ancillary hardware (e.g., keyboard, monitor, printer, scanner). Exemplary input and output for the UI module 210 is illustrated described in more detail below with reference to FIGS. 3-8.

Layout module 220 may be implemented to open or import existing layouts, generate new layouts, and populate the layout with automation devices. Layout module 220 may include a number of sub-modules, such as, import module 222, draw module 224, and device placement module 226.

Import sub-module 222 may be implemented to import an electronic layout for configuring a building automation system. For example, the electronic layout may include a floor plan for a building (or one or more rooms in the building), zones, or other areas (e.g., an outdoor landscape). Import sub-module 222 may import the electronic layout as an electronic image file (e.g., computer-aided drawing file or bitmap file). Import module 222 may operate in conjunction with software provided with external hardware, such as, e.g., design software or imaging software for a scanner device or digital camera.

Draw sub-module 224 may provide drawing tools. In an exemplary implementation, draw module includes drawing tools which allow a designer or other user to “trace” over a picture of the layout. It is noted that in alternative implementations, layout module 220 may be provided as commercially available illustration software and does not need to be integrated into the configuration application itself.

Device placement sub-module 226 may be implemented to populate an electronic layout with automation devices. In an exemplary implementation, device placement sub-module 226 may include a number of device libraries with preconfigured automation devices. Device placement sub-module 226 may also work with generic and user-defined automation devices. The automation devices may be displayed as device icons that may be moved onto the electronic layout using conventional “drag and drop” means.

Programming module 230 may be operatively associated with layout module 220 for programming automation devices populating the electronic layout. Programming module 230 may include a number of sub-modules, such as, relationships tool 232, scenes sub-module 234, and simulator sub-module 236.

Relationships tool 232 may be implemented to establish physical relationships between two or more automation devices. For example, a keypad may include control relationships with lighting control devices, input sensors, and HVAC controls. Lighting controls devices may include electrical relationships with one another. In an exemplary implementation, the automation device icons may be graphically linked to one another (e.g., using a mouse or other pointer device) to indicate electrical, control, or other relationships between the automation devices.

Scenes sub-module 234 may be implemented to generate automation programs for controlling automation devices in a prescribed manner. For example, an automation program may be assigned to lighting control devices so that the lights in the media room are gradually raised (e.g., “slew-on”) to 50% following a movie presentation over a 2 minute period to allow the users eyes to adjust.

It is noted that more than one automation program may be assigned to a single automation device. For example, a lighting control device may include a plurality of automation programs which may be executed depending on which button a user presses on a keypad device, input received from a timer or light sensor device, etc.

Simulator module 236 may be implemented to simulate output for an automation device in software (e.g., graphically). In an exemplary simulation, the background of an electronic layout may be shaded in dark gray and large white circles may be displayed to show full power being applied to high wattage loads, and gray circles may be displayed to show slew-on operations.

System management module 240 may be operatively associated with layout module 220 and programming module 230 to manage the building automation system during and after installation. System management module 240 may include a number of sub-modules, such as, commissioning sub-module 242, download/upgrade sub-module 244, and remote management sub-module 246.

Commissioning sub-module 246 may be implemented to generate program code defining device classes and corresponding processes for controlling automation devices. In an exemplary implementation, commissioning sub-module 246 may generate program code (e.g., scripts 260) for controlling automation devices. Commissioning sub-module 246 may deliver the compiled program code (or scripts) to the automation devices where the program code may be stored in memory and executed by a processor at the device during operation.

The use of program code, such as scripts, to control devices in a building automation system may be better understood by the following example. The exemplary script provided below may be generated by the configuration application 200 and delivered to a triac light controller (T1) in a building automation system. A keypad button (K1) controls the triac light controller.

[Script Header]

| Event Message | | | | Offset to the associated |
|---|---|---|---|---|
| | | | Control | script from the top of |
| Event ID | Device ID | Control ID | State | the script block. |
| MAKE | K1 | 1 | LED Off | Off-0 |
| MAKE | K1 | 1 | LED On | Off-1 |

[Script Beginning at Offset Off-0 from Top of Script Block]

| | |
|---|---|
| Off-0 | Control ID = 1, TON, 100% Power |
| | POC K1, 1, LON |
| Off-1 | Control ID = 1, TOFF |
| | POC K1, 1, LOFF |

The following command abbreviations are used in the example script:
TON=Triac On
TOFF=Triac Off
POC=Put on CAN
LON=LED On
LOFF=LED Off
MAKE//Implies a switch contact has been made. (e.g., when a user presses a button the event message that is generated has a MAKE event id.)

In operation, if the triac light controller receives a keypad command “Off-0” the script executes at the triac light controller to turn lighting on. The script also generates a signal which reports back to the keypad to turn on the corresponding LED light at the keypad. If the triac device receives the keypad command “Off-1” the script executes at the triac light controller to turn off lighting. The script also generates a signal which reports back to the keypad device to turn off the corresponding LED light at the keypad.

The exemplary script described above is provided merely to illustrate scripts which may be generated by the configuration application 200 in an exemplary implementation. It is noted that other types of scripts, more or less elaborate than the example, may be generated to control any of a wide variety of automation devices. It is further noted that the configuration application 200 may generate other types of program code and is not limited to generating scripts.

Turning again to the configuration application 200 in FIG. 2, download/upgrade sub-module 244 may be implemented to automatically or manually upgrade scripts and/or firmware for the automation devices. In an exemplary implementation, download/upgrade module 244 may be operatively associated with a remote management sub-module 246 so that changes to the program code may be effected from a monitoring station or headquarters for a plurality of building automation systems.

Remote management sub-module 246 may be implemented to communicate with the building automation system (e.g., the bridge) via a remote connection. Accordingly, an integrator or other user may connect to the building automation system off-site and change the configuration of the building automation system, e.g., to add or remove an automation device, monitor the status of automation subsystems, receive error reports, etc.

Documentation module 250 may be operatively associated with the layout module 220 and programming module 230 to generate documentation for the building automation system and/or automation devices in the automation system. Documentation module 250 may include a number of sub-modules, such as, system documentation sub-module 252, labeling sub-module 254, and BOM sub-module 256.

System documentation sub-module 252 may generate documentation for the building automation system, such as, floor plans showing physical placement of the automation devices, and/or the documentation for describing how the automation devices should be wired, where the wiring runs, etc.

In an exemplary implementation, documentation may be generated for an electrician, e.g., for each of the modules to show how it is to be wired during installation. Electrical wiring documentation may include a representation of the module (e.g., a digital photograph) and labeled inputs to show the electrician which wires should be attached to the automation device.

Labeling sub-module 254 may be implemented to generate wiring labels, e.g., for each wire that is pulled to a module so that the wires can be easily identified during installation and/or maintenance. Labels may be also be generated for automation devices, including text and/or graphics (e.g., icons, borders, etc.). For example, labels may be generated for a keypad and printed and placed into a keypad to describe button functions on the keypad for a user.

Bill of materials (BOM) sub-module 256 may be implemented to receive input from layout module 220 and programming module 230 during design of the building automation system. BOM sub-module 256 generates and maintains a bill of materials for each of the automation devices populating the electronic layout. BOM sub-module 256 may also automatically determine the amount and type of wiring needed to install the automation devices in the building automation system, e.g., based on relationships defined by relationships tool 232.

Before continuing, it is noted that exemplary configuration application 200 is shown and described herein merely for purposes of illustration and is not intended to be limited to any particular implementation. For example, modules 210-250 do not need to be encapsulated as separate functional components. In addition, other functional components may also be provided and are not limited to those shown and described herein.

FIGS. 3-8 are exemplary graphical user interfaces that may be displayed by a configuration application. The graphical user interface (GUI) may be implemented in a “windows” operating system environment (e.g., Microsoft Corporation's WINDOWS®), although the user interface is not limited to use with any particular operating system.

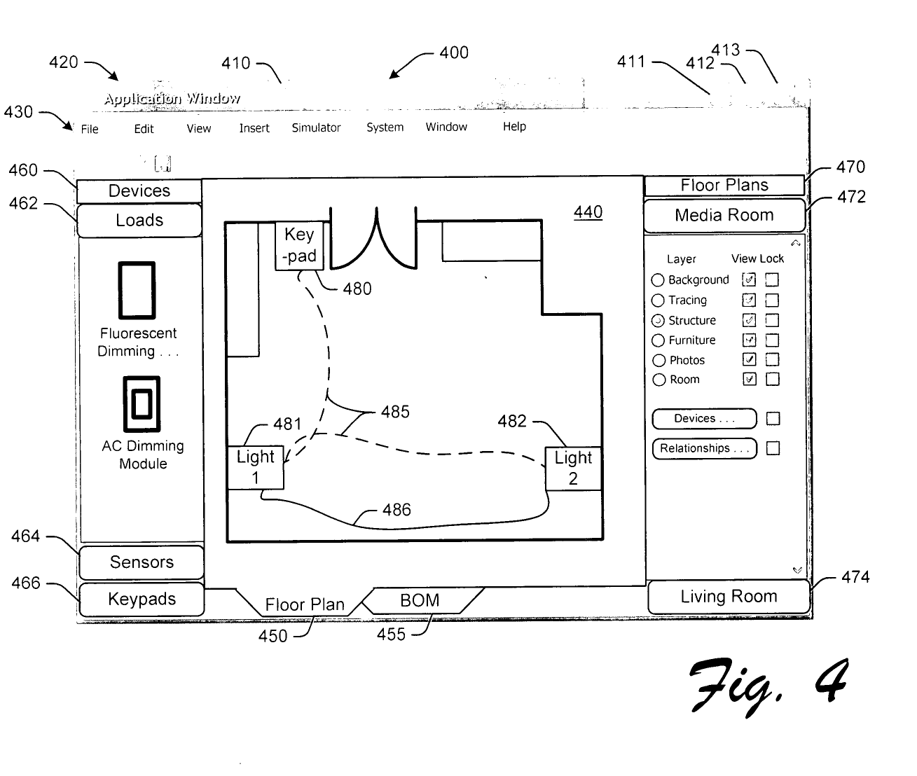

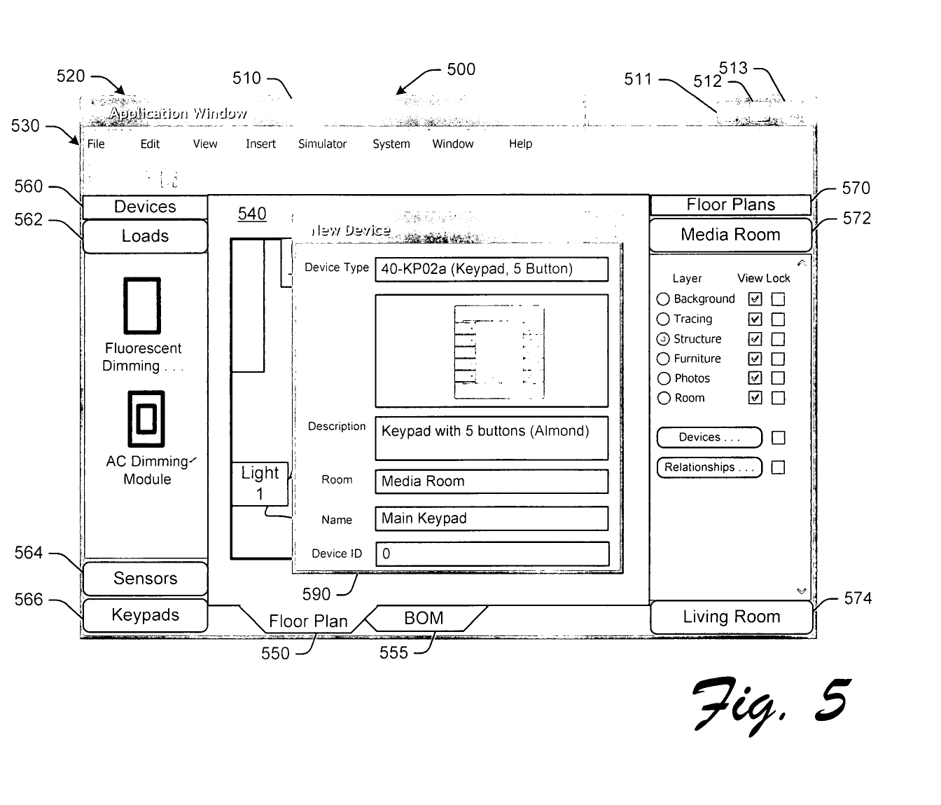

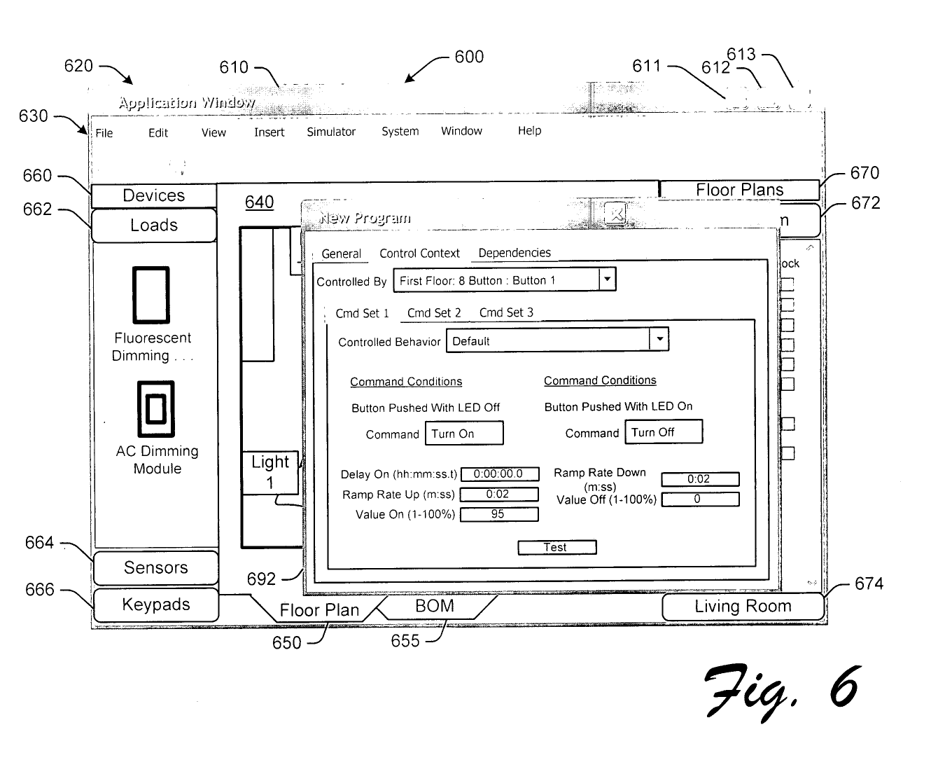

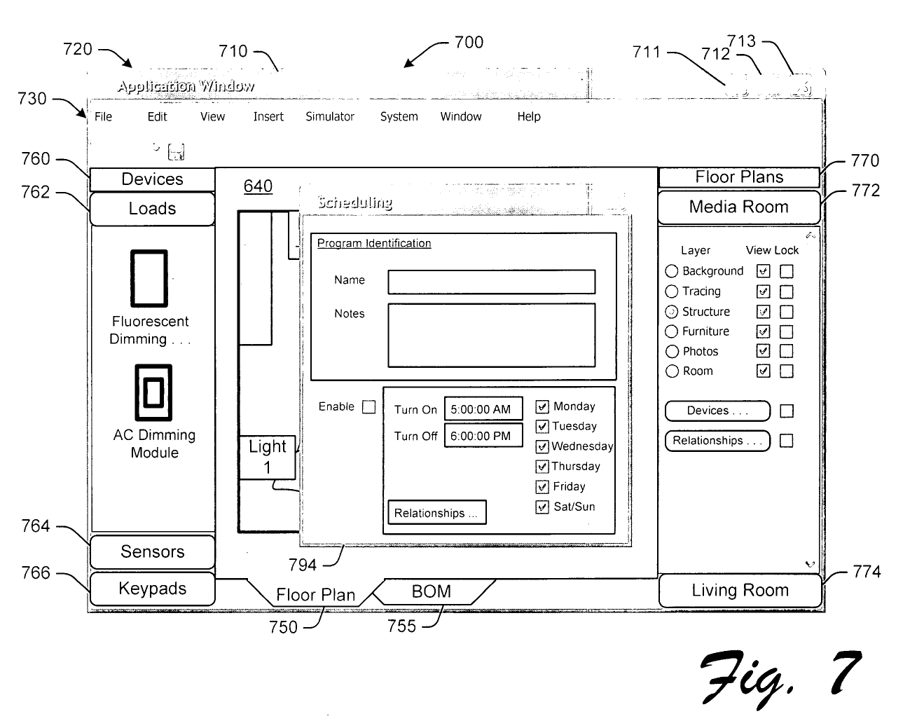

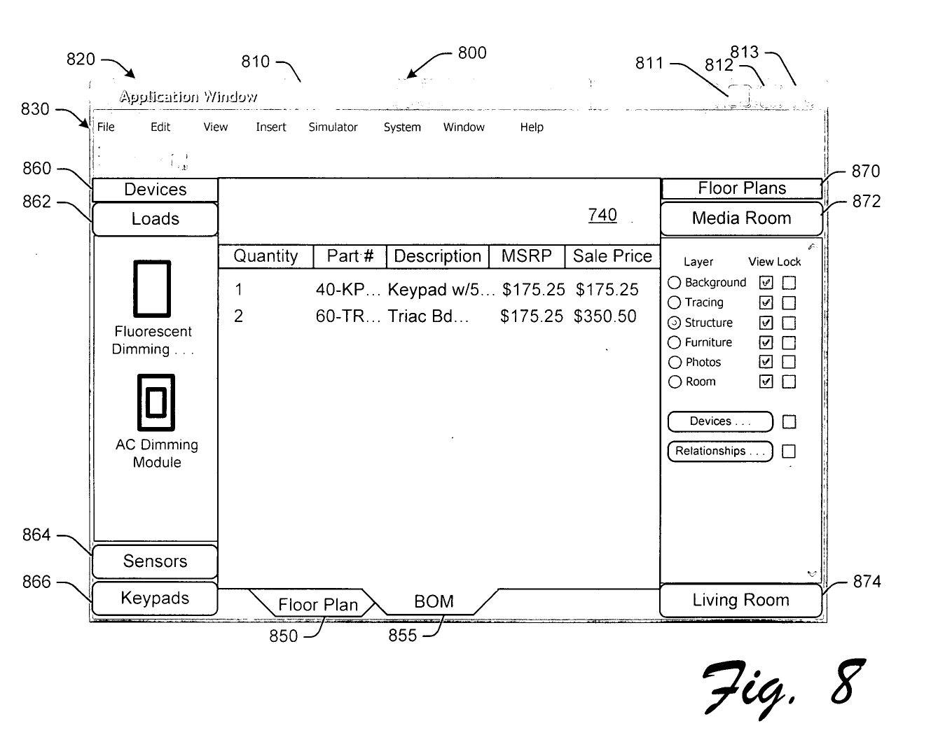

The graphical user interface is described generally with reference to FIG. 3, although it is noted that like reference numerals are used to refer to like components in each of the figures, with 400-series used in FIG. 4, 500-series used in FIG. 5, 600-series used in FIG. 6, 700-series used in FIG. 7, and 800-series used in FIG. 8.

FIG. 3 is an exemplary graphical user interface 300 that may be associated with an interface application (e.g., the configuration application 200 in FIG. 2). The user may launch the graphical user interface 300 in a customary manner, for example, by clicking on an icon, selecting the program from a menu, or pressing a key on a keyboard.

The graphical user interface 300 supports user interaction through common techniques, such as a pointing device (e.g., mouse, style), keystroke operations, or touch screen. By way of illustration, the user may make selections using a mouse to position a graphical pointer and click on a label or button displayed in the graphical user interface 300. The user may also make selections by entering a letter for a menu label while holding the ALT key (e.g., “ALT+letter” operation) on a keyboard. In addition, the user may use a keyboard to enter command strings (e.g., in a command window).

The graphical user interface 300 is displayed for the user in a window, referred to as the “application window” 310, as is customary in a window environment. The application window 310 may include customary window functions, such as a Minimize Window button 311, a Maximize Window button 312, and a Close Window button 313. A title bar 320 identifies the application window 310. The application window 310 may also include a customary menu bar 330 having an assortment of pull down menus (e.g., labeled “File,” “Edit,” “View,” “Insert,” “Simulator,” “System,” “Window,” and “Help”). For example, the user may select a print function (not shown) from the “File” menu (designated herein as “File|Print”).

It is noted that the menu bar 330 may include any of a wide variety of different menus which are displayed when a pull down menu is selected. The menus may include standard menu options (e.g., File|Open, File|Save, File|Print, Edit|Copy, Edit|Cut, Edit|Paste, etc.). In addition, the menus may also include menu options which are specific to the configuration application (e.g., Simulator|Run, Simulator|Stop).

Application window 310 also includes an operation space 340. Operation space 340 may include one or more graphics for displaying output and/or facilitating input from the user. Graphics may include, but are not limited to, subordinate windows, dialog boxes, icons, text boxes, buttons, and check boxes.

Exemplary operation space 340 includes tabs for selecting between a “Floor Plans” preview window 350 and a “Bill of Materials” preview window 355. Selecting the preview window 350 displays the layout for the building, room, or zone layout, as shown in FIG. 3. Preview window 355 is described in more detail below with reference to the bill of materials shown in FIG. 8. Exemplary operation space 340 may also include tools such as a “Device” tools window 360 and a “Floor Plans” tools window 370.

The device tools window 360 displays device options, such as, e.g., “Loads” 362, “Sensors” 364, and “Keypads” 366. Device options may be displayed as device icons, such as, e.g., fluorescent dimming ballast and AC dimming module. The Floor Plans tools window 370 provides a selection between layouts for the building, such as, e.g., “Media Room” 372 or “Living Room” 374.

A user, such as the integrator or building owner, may configure a building automation system using the graphical user interface 300 to execute the user interface application (e.g., 200 in FIG. 2). For purposes of illustration, a user may select File|Open from the menu bar 330 to open an existing layout. The user may then populate the layout with automation devices by dragging and dropping device icons onto preview window 350.

FIG. 4 is an exemplary graphical user interface 400 illustrating automation devices populating a layout. For purposes of illustration, a keypad device 480 and two lighting control devices 481, 482 are positioned on the layout of the media room. Graphical user interface 400 also illustrates relationships between automation devices. In an exemplary implementation, the user may “draw” lines connecting the devices to establish relationships. For purposes of illustration, control wiring 485 linking keypad 480 to lighting control devices 481, 482, and electrical wiring 486 linking lighting control devices 481, 482 to one another illustrate exemplary relationships.

FIG. 5 is an exemplary graphical user interface 500 illustrating configuration data for an automation device. In an exemplary implementation, a user may “right-click” on one of the automation devices to display configuration data for the device. For purposes of illustration, keypad device 480 (FIG. 4) is shown selected in FIG. 5, and a subordinate window 590 displays configuration information for the keypad device. Configuration data may include, but is not limited to, the device type, a picture of the actual device, a description of the device, the room in which the device is to be installed, a user-friendly name, and device ID.

FIG. 6 is an exemplary graphical user interface 600 illustrating device programming. In an exemplary implementation, a user may select an automation device and then select a programming option from the menu. For purposes of illustration, lighting control device 481 (FIG. 4) is shown selected in FIG. 6, and a subordinate window 692 displays programming options. Programming options may include, but are not limited to, command sets, command conditions, and device commands.

FIG. 7 is an exemplary graphical user interface 700 illustrating device scheduling. Device scheduling may include, e.g., running the landscape sprinklers or outdoor lighting on a predetermined schedule. In an exemplary implementation, a user may select an automation device and then select a scheduling option from the menu. For purposes of illustration, lighting control device 481 (FIG. 4) is shown selected in FIG. 7, and a subordinate window 794 displays scheduling options. Scheduling options may include, but are not limited to, schedule identification, and an automatic timing program for turning on and off the automation device (e.g., lighting).

FIG. 8 is an exemplary graphical user interface 800 illustrating a bill of materials (BOM) 855 for the building automation system. A bill of materials 855 may be automatically generated as the building automation system is configured. For example, when the user drags and drops a keypad device icon onto the layout, a keypad device is automatically added to the BOM 855, along with an item description and cost information, as maintained in a database associated with the configuration application. The user may select the BOM 855 at any time during the configuration process to determine the quantity of materials, current pricing, and other information for a project.

### Exemplary Operations

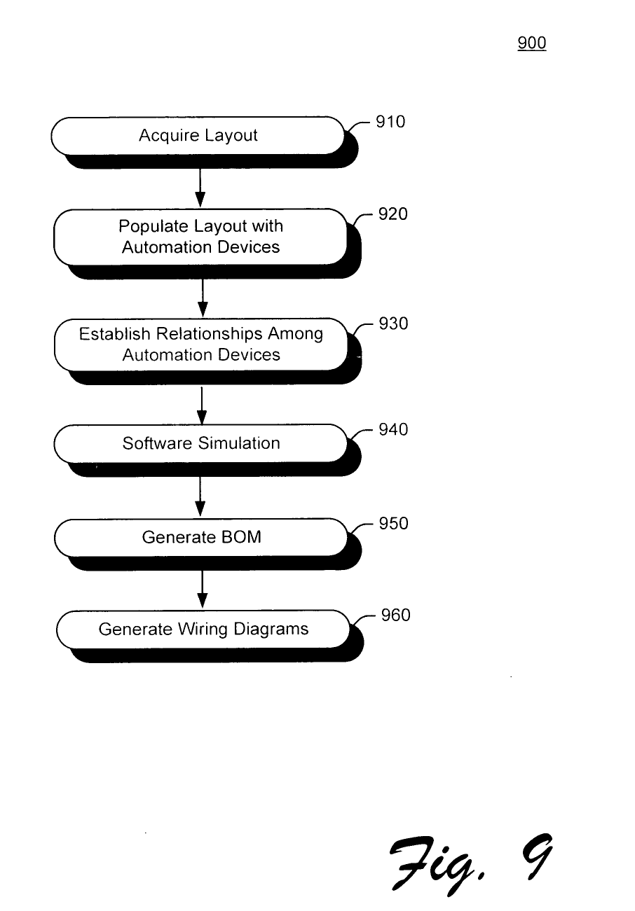

FIGS. 9-12 are flow diagrams illustrating exemplary operations that may be implemented by a configuration application. The methods described herein may be embodied as logic instructions. When executed on a processor (or processing devices), the logic instructions cause a general purpose computing device to be programmed as a special-purpose machine that implements the described methods.

FIG. 9 is a flow diagram illustrating exemplary operations 900 for configuring a building automation system. In operation 910 an electronic layout may be acquired. For example, the electronic layout may be acquired by importing a computer generated file or scanning an image. In operation 920 the electronic layout may be populated with automation devices. In operation 930 relationships are established amount the automation devices.

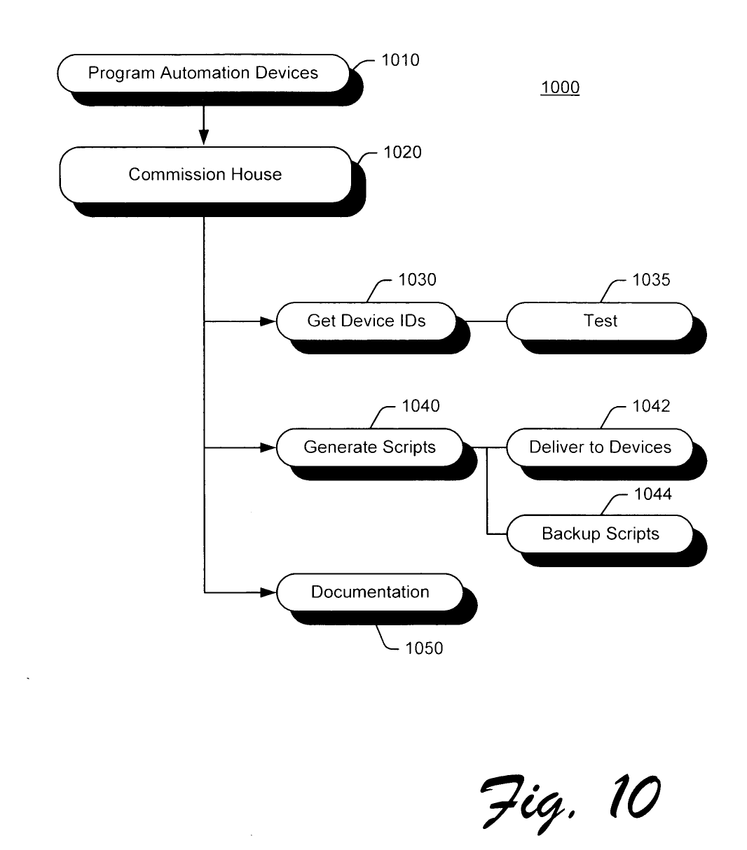

Optionally, in operation 940 the building automation system may be simulated in software. Also optionally, in operation 950 a bill of materials (BOM) may be generated. In yet another optional operation 960, a wiring diagram may be generated. Still other exemplary operations are described with reference to FIG. 10.

FIG. 10 is a flow diagram illustrating exemplary operations 1000 for commissioning a building automation system. In operation 1010 the automation devices may be programmed, e.g., using scripts generated by the configuration application for the automation devices. In operation 1020 the building automation system may be commissioned. Commissioning the building automation system may include any of a wide variety of operations.

For purposes of illustration, commissioning the house may include obtaining device IDs for the automation devices installed in the building automation system in operation 1030. The automation devices may be tested in operation 1035. Optionally, the automation devices may be tested in software without having to download the scripts to the automation devices. According, changes can be made quickly and conveniently.

Commissioning the house may also include generating scripts in operation 1040 for controlling the automation devices. The scripts may be delivered to the automation devices in operation 1042. Optionally, a backup copy of the scripts may be stored in the building automation system (e.g., on the bridge 140) in operation 1044.

Commissioning the house may also include generating documentation for the building automation system. Exemplary documentation may include, but is not limited to, instruction manuals and/or maintaining the building automation system. The documentation may be printed or stored electronically (e.g., on the bridge 140).

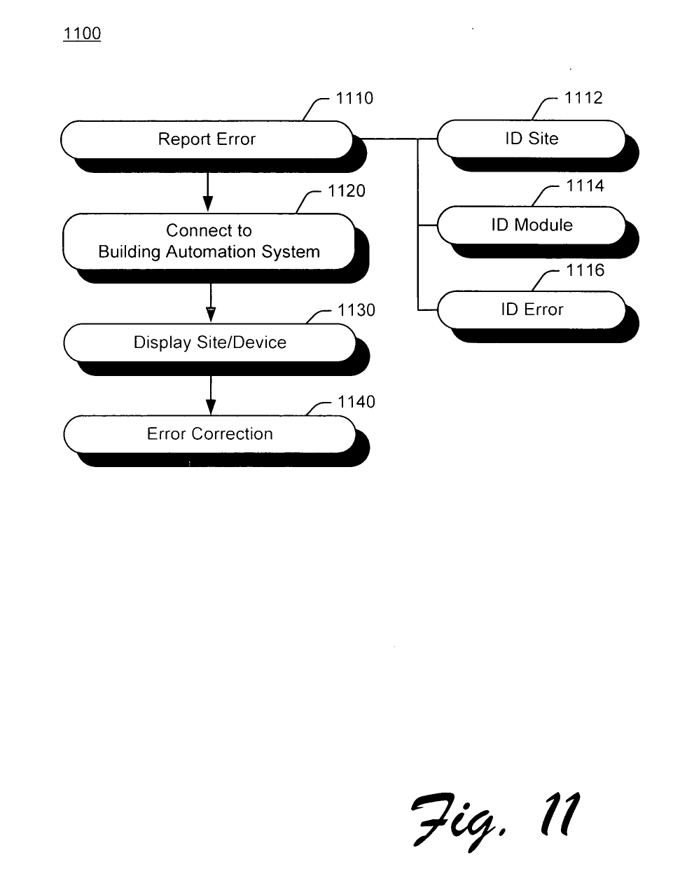

FIG. 11 is a flow diagram illustrating exemplary operations 1100 for automatic error reporting for a building automation system. In operation 1110 an error may be reported. Error reporting may include identifying the site (e.g., the building address or customer name), identifying the automation device experiencing the error (e.g., triac ID #### or lighting ID ####), and identifying the error itself (e.g., “overheating triac” or “burned-out bulb”).

In operation 1120 a connection may be established with the building automation system. For example, a remote connection may be established from a service center. In operation 1130 the site and device may be displayed (e.g., for a service center representative) and the error may be corrected in operation 1140. For example, the service center representative may remotely disconnect an overheating triac or may notify the building owner to disconnect an overheating triac until a repair can be made.

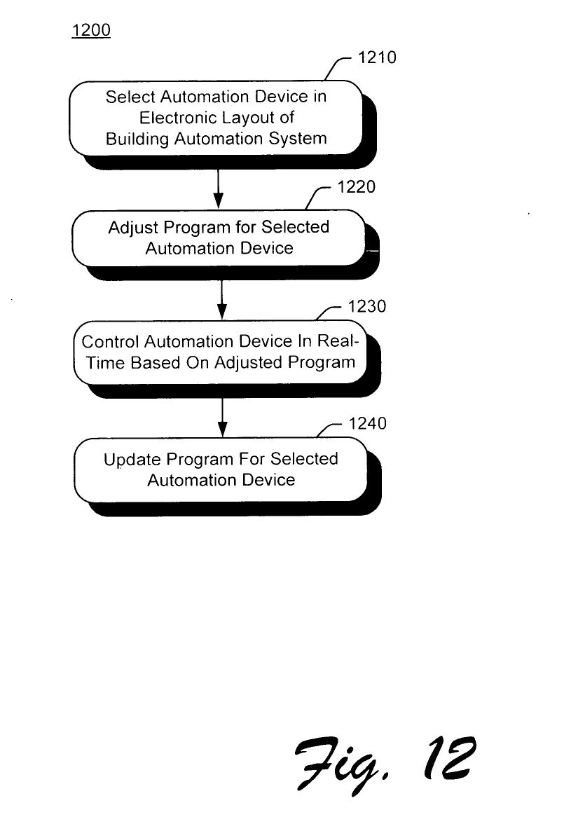

FIG. 12 is a flow diagram illustrating exemplary operations 1200 for programming automation devices for a building automation system in real-time. In operation 1210 an automation device is selected from the electronic layout of the building automation system. In operation 1220 the program for the selected automation device is adjusted.

Optionally, the program may be adjusted based on user feedback in real-time. For purposes of illustration, a user may right click on a device icon in the layout and select the “Control” menu item. The device appropriate control dialog is displayed and, after appropriate credentials have been exchanged, allows the user to change the settings for that device, real time. The user can alternatively select “Properties” to bring up the Devices Property Sheet. If the automation device is a controlling device, such as a keypad, the user may select the “Scenes” tab and modify command parameters for loads in the current scene. The “Update Live Load” button commands the configuration application to force the parameters to be sent to the live load in real-time, allowing the home owner to stand in a room and call out setting changes. For example, the user may call out “a little brighter, a little brighter, not too bright, got it!” Following the adjustment the settings may be saved.

In operation 1230 the automation device is controlled in real time based on the adjusted program. For example, if a program for a light control device is changed so that the lights dim to 50% the light control will dim to 50%. Accordingly, the user is able to determine in real-time whether the change is acceptable. In operation 1240 the selected automation device may be updated with the adjusted program, e.g., by downloading new or revised scripts to the selected automation device in the building automation system.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method of configuring automation devices in a building automation system comprising:
acquiring an electronic layout for the building automation system;
populating the electronic layout with a plurality of automation devices; and
establishing relationships among the automation devices in the electronic layout.

2. The method of claim 1, wherein acquiring the electronic layout includes importing an electronic image of a floor plan.

3. The method of claim 1, wherein acquiring the electronic layout includes tracing an electronic image of a floor plan.

4. The method of claim 1, further comprising simulating operation of the automation devices.

5. The method of claim 1, further comprising generating a Bill of Materials (BOM) for the building automation system based on the automation devices populating the electronic layout.

6. The method of claim 1, further comprising generating a device label for at least one of the automation devices populating the electronic layout based on the relationships among the automation devices in the electronic layout.

7. The method of claim 1, further comprising programming the automation devices populating the electronic layout.

8. The method of claim 1, further comprising generating scripts for the automation devices populating the electronic layout and delivering the generated scripts to corresponding automation devices in the building automation system.

9. The method of claim 8, further comprising storing a backup copy of the scripts in the building automation system.

10. The method of claim 1, further comprising generating documentation for the building automation system based on the automation devices populating the electronic layout.

11. The method of claim 1, further comprising testing automation devices in the building automation system before delivering scripts to the automation devices.

12. The method of claim 1, further comprising commissioning automation devices in the building automation system based on the automation devices populating the electronic layout and the established relationships.

13. The method of claim 1, further comprising automatically updating program code for automation devices in the building automation system based on the automation devices populating the electronic layout.

14. The method of claim 1, further comprising remotely managing automation devices in the building automation system based on the automation devices populating the electronic layout.

15. A method of reporting errors for automation devices in a building automation system comprising:
identifying a device error in the building automation system;
connecting to the building automation system; and
reporting the device error for real-time analysis.

16. The method of claim 15, wherein identifying the device error includes identifying a site and automation device experiencing the device error.

17. A method of configuring automation devices for a building automation system in real-time comprising:
identifying an automation device in an electronic layout of the building automation system;
adjusting a program for the automation device;
controlling the automation device while adjusting the program; and
programming the automation device with the adjusted program.

18. The method of claim 17, wherein adjusting the program is based on user feedback.

19. A computer program product encoding a computer process for configuring automation devices in a building automation system, the computer process comprising:
acquiring an electronic layout for the building automation system;
populating the electronic layout with a plurality of automation devices; and
establishing relationships among the automation devices in the electronic layout.

20. The computer program product of claim 19 wherein the computer process further acquires the electronic layout includes importing an electronic image of a floor plan.

21. The computer program product of claim 19 wherein the computer process further acquires the electronic layout includes tracing an electronic image of a floor plan.

22. The computer program product of claim 19 further comprising a drag-and-drop interface for populating the electronic layout with the automation devices.

23. The computer program product of claim 19 wherein the computer process further simulates operation of the automation devices.

24. The computer program product of claim 19 wherein the computer process further generates a Bill of Materials (BOM) for the building automation system based on the automation devices populating the electronic layout.

25. The computer program product of claim 19 wherein the computer process further generates a device label for at least one of the automation devices populating the electronic layout based on the relationships among the automation devices in the electronic layout.

26. The computer program product of claim 19 wherein the computer process further generates documentation for the building automation system based on the automation devices populating the electronic layout.

27. The computer program product of claim 19 wherein the computer process further tests automation devices in the building automation system before delivering scripts to the automation devices.

28. The computer program product of claim 19 wherein the computer process further commissions automation devices in the building automation system using scripts based on the automation devices populating the electronic layout and the established relationships.
